(19) United States
(12) Patent Application Publication
(10) Pub. No.: US 2017/0193879 A1
(43) Pub. Date: Jul. 6, 2017

(54) PIXEL COMPENSATION CIRCUIT AND METHOD FOR DRIVING THE SAME, DISPLAY PANEL AND DISPLAY DEVICE

(71) Applicant: BOE TECHNOLOGY GROUP CO., LTD., Beijing (CN)

(72) Inventor: Yu Wang, Beijing (CN)

(21) Appl. No.: 15/214,204

(22) Filed: Jul. 19, 2016

(30) Foreign Application Priority Data
Jan. 5, 2016 (CN) 201610006982.4

(51) Int. Cl. G09G 3/20; G09G 3/38

(52) U.S. Cl. CPC G09G 3/2018; G09G 3/38; G09G 2300/0819; G09G 2300/0426; G09G 2310/061; G09G 2320/0626; G09G 2310/027

(57) ABSTRACT

An embodiment of the present disclosure provides a pixel compensation circuit and method for driving the same, a display panel and a display device. The pixel compensation circuit comprises a resetting module, a data writing module, a compensation module, a driving module and a light emitting device. The embodiment of the present disclosure may prevent from issues of instability of voltage caused by different threshold voltages by cooperative operations of the respective modules of the pixel compensation circuit. When the light emitting device is controlled by the driving module to display, the difference value between a threshold voltage as well as a voltage difference between the control terminal of the compensation module and the output terminal of the compensation module is irrespective of the threshold voltage, so that the voltage supplied to the light emitting device will not be affected by the threshold voltage. Thus, the embodiment of the present disclosure provides a pixel compensation circuit to solve the technical problem of instability of voltages supplied to the light emitting device caused by different threshold voltage Vth, thereby improving uneven displaying of the display panel and being capable of displaying frames with low grey scale by the display panel.

This application claims priority to Chinese Application No. 201610006982.4, filed on Jan. 5, 2016, entitled “PIXEL COMPENSATION CIRCUIT AND METHOD FOR DRIVING THE SAME, DISPLAY PANEL AND DISPLAY DEVICE”, which is incorporated herein by reference in their entireties.

### FIELD OF INVENTION

The present invention relates to a technical field of electroluminescence field, especially to a pixel compensation circuit and method for driving the same, a display panel and display device.

### DESCRIPTION OF PRIOR ART

With development of science and technology, there are much more types of display devices. With economic progress, it is focused on saving of energy. Thus, the present display products play attention to issues of power consumption. Electro chromic Device (ECD) is paid attention to by researchers for its low power consumption, low cost, self-illumination, wide view angle, rapid response speed and so on. For example, since ECD has a character of not-consuming power and transparent displaying while maintaining graphs, it has been successfully applied to products such as color changing window in plane, tunable rearview mirror and so on. Meanwhile, ECD has an incomparable advantage in future large advertisement board, transparent showcase.

However, due to voltage characteristic and capacitance characteristic of ECD light emitting device, when a conventional display driving method is utilized to drive the light emitting device, different threshold voltage Vth in the driving circuit may lead to instability of voltages supplied to the light emitting device, thereby resulting in uneven displaying of the display panel and being incapable of displaying frames with low grey scale.

### SUMMARY OF THE INVENTION

An embodiment of the present disclosure provides a pixel compensation circuit and method for driving the same, a display panel and a display device which may solve the technical problem of instability of voltages supplied to the light emitting device caused by different threshold voltage Vth, thereby improving uneven displaying of the display panel and being capable of displaying frames with low grey scale by the display panel.

The embodiment of the present disclosure provides a pixel compensation circuit comprising a resetting module, a data writing module, a compensation module, a driving module and a light emitting device; wherein a control terminal of the resetting module is connected to a first square wave signal, and an input terminal of the resetting module is connected to a power supply voltage signal; the resetting module is configured to supply the power supply voltage signal to the input terminal of the compensation module under control of the first square wave signal; a control terminal of the data writing module is connected to a second square wave signal, and an input terminal of the data writing module is connected to a data signal; the data writing module is configured to supply a voltage signal of the data signal to the control terminal of the compensation module under control of the second square wave signal; a control terminal of the compensation module is connected to an output terminal of the data writing module, and the input terminal of the compensation module is connected to an output terminal of the resetting module; the compensation module is configured to supply a voltage signal output by the output terminal of the resetting module to an input terminal of the driving module under control of a voltage signal output by the output terminal of the data writing module, and a difference value between a threshold voltage as well as a voltage difference between the control terminal of the compensation module and the output terminal of the compensation module is irrespective of the threshold voltage; a control terminal of the driving module is connected to a third square wave signal, and the input terminal of the driving module is connected to the output terminal of the compensation module; the driving module is configured to drive the light emitting device under control of the third square wave signal.

In one optional embodiment, in the pixel compensation circuit according to an embodiment of the present disclosure, the resetting module particularly comprises a first switch transistor, wherein a gate of the first switch transistor is the control terminal of the resetting module, the first electrode of the first switch transistor is the input terminal of the resetting module, and the second electrode of the first switch transistor is the output terminal of the resetting module.

In one optional embodiment, in the pixel compensation circuit according to an embodiment of the present disclosure, the data writing module particularly comprises a second switch transistor, wherein a gate of the second switch transistor is the control terminal of the data writing module, the first electrode of the second switch transistor is the input terminal of the data writing module, and the second electrode of the second switch transistor is the output terminal of the data writing module.

In one optional embodiment, in the pixel compensation circuit according to an embodiment of the present disclosure, the compensation module particularly comprises a third switch transistor, a first capacitor and a second capacitor, wherein a gate of the third switch transistor is the control terminal of the compensation module, the first electrode of the third switch transistor is the input terminal of the compensation module, and the second electrode of the third switch transistor is the output terminal of the compensation module; the first electrode plate of the first capacitor is connected to the control terminal of the third switch transistor, and the second electrode plate of the first capacitor is connected to the second electrode of the third switch transistor; and the second capacitor is connected between the first capacitor and the ground.

In one optional embodiment, in the pixel compensation circuit according to an embodiment of the present disclosure, the driving module particularly comprises a fourth switch transistor, wherein a gate of the fourth switch transistor is the control terminal of the driving module, the first electrode of the fourth switch transistor is the input terminal of the driving module, and the second electrode of the fourth switch transistor is the output terminal of the driving module.

In one optional embodiment, in the pixel compensation circuit according to an embodiment of the present disclosure, the first, second, third and fourth switch transistors are all P-type transistors or N-type transistors.

Correspondingly, the embodiment of the present disclosure provides a display panel comprising any one of the pixel compensation circuits according to the embodiment of the present disclosure.

Correspondingly, the embodiment of the present disclosure provides a display device comprising the display panel according to the embodiment of the present disclosure.

Correspondingly, the embodiment of the present disclosure further provides a method for driving the pixel compensation circuit as mentioned above. The method comprises: during a resetting stage, the resetting module is configured to reset a voltage potential at the output terminal of the compensation module under control of the first square wave signal; during a compensating stage, the resetting module compensates a voltage potential at the output terminal of the compensation module under the first square wave signal; during a data writing stage, the date writing module is configured to write the potentials at the control terminal and the output terminal of the compensation module under control of the second square wave signal, so that a difference value between a threshold voltage as well as a voltage difference between the control terminal of the compensation module and the output terminal of the compensation module is irrespective of the threshold voltage; and during a displaying stage, the driving module is configured to drive the light emitting device under control of the third square wave signal.

The embodiment of the present disclosure may prevent from issues of instability of voltage caused by different threshold voltages by cooperative operations of the respective modules of the pixel compensation circuit. When the light emitting device is controlled by the driving module to display, the difference value between a threshold voltage as well as a voltage difference between the control terminal of the compensation module and the output terminal of the compensation module is irrespective of the threshold voltage, so that the voltage supplied to the light emitting device will not be affected by the threshold voltage. Thus, the embodiment of the present disclosure provides a pixel compensation circuit to solve the technical problem of instability of voltages supplied to the light emitting device caused by different threshold voltage Vth, thereby improving uneven displaying of the display panel and being capable of displaying frames with low grey scale by the display panel.

### BRIEF DESCRIPTION OF THE DRAWINGS

FIG. 1 is a schematic view of the configuration of the pixel compensation circuit according to the embodiment of the present disclosure;

FIG. 2 is a schematic view of the first particular configuration of the pixel compensation circuit according to the embodiment of the present disclosure;

FIG. 3 is a schematic view of the second particular configuration of the pixel compensation circuit according to the embodiment of the present disclosure;

FIG. 4a is a schematic view of the third particular configuration of the pixel compensation circuit according to the embodiment of the present disclosure;

FIG. 4b is a schematic view of the fourth particular configuration of the pixel compensation circuit according to the embodiment of the present disclosure;

FIG. 5a is a circuit timing chart of the pixel compensation circuit as shown in FIG. 4a;

FIG. 5b is a circuit timing chart of the pixel compensation circuit as shown in FIG. 4b;

FIG. 6 is a schematic view of a flowchart of the method for driving the pixel compensation circuit according to the embodiment of the present disclosure.

### DETAILED DESCRIPTION OF PREFERRED EMBODIMENTS

The technical solutions of the embodiments of the present disclosure will be described clearly and completely below in conjunction with accompanying drawings of the present disclosure. Obviously, the embodiments described are merely a part of embodiments of the present disclosure instead of all embodiments. All other embodiments obtained by an ordinary skilled in the art based on the embodiments of the present disclosure without contributing any creative labor should belong to the protection scope of the present disclosure.

The embodiment of the present disclosure provides a pixel compensation circuit and method for driving the same, a display panel and a display device which may solve the technical problem of instability of voltages supplied to the light emitting device caused by different threshold voltage Vth, thereby improving uneven displaying of the display panel and being capable of displaying frames with low grey scale by the display panel.

In conjunction with accompany figures, the particular embodiments of the pixel compensation circuit and a method for driving the same, the display panel and the display device according to the present disclosure will be illustrated in detail.

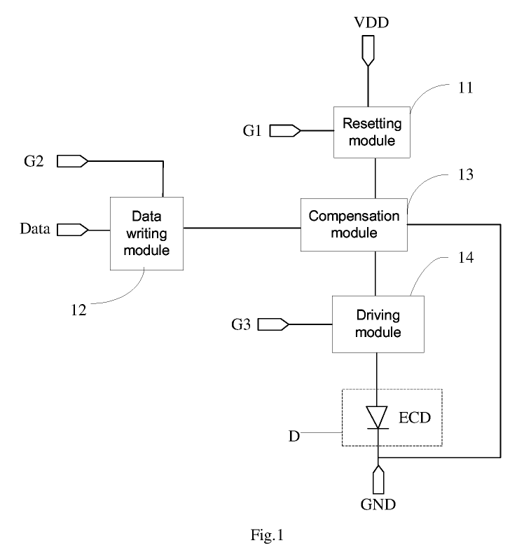

By referring to FIG. 1, the embodiment of the present disclosure provides a pixel compensation circuit comprising a resetting module 11, a data writing module 12, a compensation module 13, a driving module 14 and a light emitting device D. A control terminal of the resetting module 11 is connected to a first square wave signal G1, an input terminal of the resetting module 11 is connected to a power supply voltage signal VDD, and an output terminal of the resetting module 11 is connected to an input terminal of the compensation module 13. The resetting module 11 is configured to supply the power supply voltage signal VDD to the input terminal of the compensation module 13 under control of the first square wave signal G1.

A control terminal of the data writing module 12 is connected to a second square wave signal G2, and an input terminal of the data writing module 12 is connected to a data signal DATA; an output terminal of the data writing module 12 is connected to the control terminal of the compensation module 13; the data writing module 12 is configured to supply a voltage signal of the data signal DATA to the control terminal of the compensation module 13 under control of the second square wave signal G2.

A control terminal of the compensation module 13 is connected to an output terminal of the data writing module 12, and the input terminal of the compensation module 13 is connected to an output terminal of the resetting module 11; an output terminal of the compensation module 13 is connected to an input terminal of the driving module 14; and the compensation module 13 is configured to supply a voltage signal output by the output terminal of the resetting module 11 to the input terminal of the driving module 14 under control of a voltage signal output by the output terminal of the data writing module 12, and a difference value between a threshold voltage as well as a voltage difference between the control terminal of the compensation module 13 and the output terminal of the compensation module 13 is irrespective of the threshold voltage; a control terminal of the driving module is connected to a third square wave signal.

The output terminal of the compensation module 13 is connected to the input terminal of the driving module 14, and the compensation module 13 is configured to supply the voltage signal output by the output terminal of the resetting module 11 to the input terminal of the driving module 14 under the voltage signal output by the output terminal of the data writing module 12, and the difference value between a threshold voltage as well as a voltage difference between the control terminal of the compensation module 13 and the output terminal of the compensation module 13 is irrespective of the threshold voltage Vth.

The control terminal of the driving module 14 is connected to a third square wave signal G3, the input terminal of the driving module 14 is connected to the output terminal of the compensation module 13, and the output terminal of the driving module is connected to the light emitting device D; and the driving module 14 is configured to drive the light emitting device D under control of the third square wave signal G3.

The pixel compensation circuit may prevent from issues of instability of voltage caused by different threshold voltages by cooperative operations of the respective modules. When the light emitting device is controlled by the driving module to display, the difference value between the threshold voltage as well as a voltage difference between the control terminal of the compensation module and the output terminal of the compensation module is irrespective of the threshold voltage, so that the voltage supplied to the light emitting device will not be affected by the threshold voltage. Thus, the embodiment of the present disclosure provides a pixel compensation circuit to solve the technical problem of instability of voltages supplied to the light emitting device caused by different threshold voltage Vth, thereby improving uneven displaying of the display panel and being capable of displaying frames with low grey scale by the display panel.

The present invention will be illustrated in detail in conjunction with the particular embodiments. It should be noted that the present embodiment is intended to further explain the present invention rather than limiting the present invention.

It should be illustrated that the first square wave signal G1, second square wave signal G2 and the third square wave signal G3 are all pulse signals with varied high and low levels, in which the high level is higher than that of the threshold voltage Vth and the low level is lower than or equal to a level of 0V. In the present embodiment, the data signal DATA provided in the embodiment of the present disclosure may be signals with varied high and low levels, in which the low level of DATA is a voltage of a reference voltage Vref, the voltage of which is larger than that of Vth, and the high level of DATA is denoted as VD, which may be any value larger than the voltage of Vref, e.g. 16V or higher. The low level of the power supply voltage signal VDD in the embodiment of the present disclosure is 0V, and its high level may be set according to type of the light emitting device which is actually controlled and is not particularly defined in the embodiment of the present disclosure.

In a particular embodiment, the light emitting device in the pixel compensation circuit according to the embodiment of the present disclosure may be an ECD light emitting device or other light emitting device.

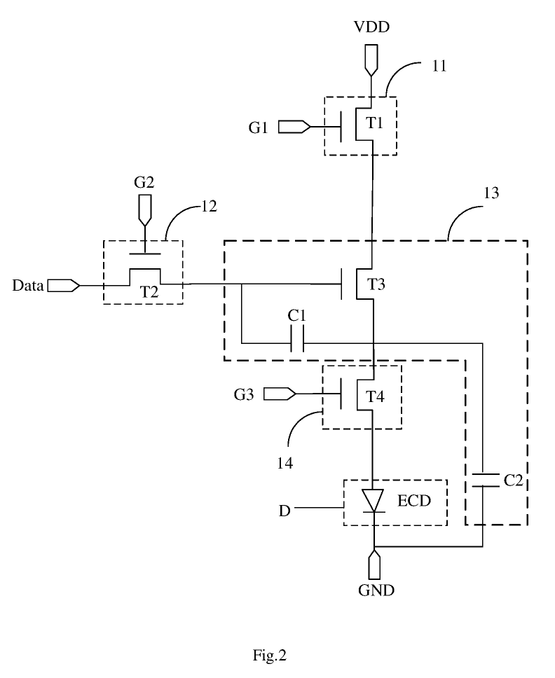

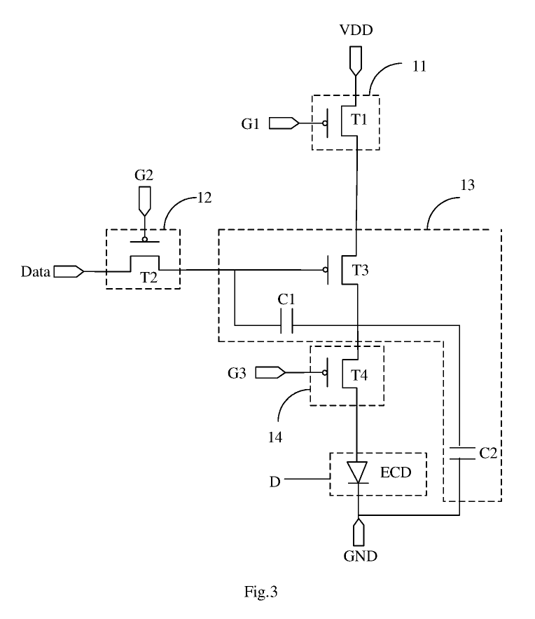

Preferably, in the pixel compensation circuit according to the embodiment of the present disclosure, as shown in FIG. 2 and FIG. 3, the resetting module 11 particularly comprises a first switch transistor T1.

A gate of the first switch transistor T1 is the control terminal of the resetting module 11 and is connected to the first square wave signal G1. The first electrode of the first switch transistor T1 is the input terminal of the resetting module 11 and is connected to the power supply voltage signal VDD. The second electrode of the first switch transistor T1 is the output terminal of the resetting module and is connected to the input terminal of compensation module 13.

Furthermore, as shown in FIG. 2, the first switch transistor T1 may be an N-type transistor. At this moment, when the first square wave signal G1 is at a high level, the first switch transistor T1 is in an on-state; and when the first square wave signal G1 is at a low level, the first switch transistor T1 is in an off-state. As shown in FIG. 3, the first switch transistor T1 may be a P-type transistor. At this moment, when the first square wave signal G1 is at a low level, the first switch transistor T1 is in an on-state; and when the first square wave signal G1 is at a high level, the first switch transistor T1 is in an off-state, which is not particularly limited.

In particular, in the pixel compensation circuit according to the embodiment of the present disclosure, when the first switch transistor T1 is in an on-state under control of the first square wave signal G1, the power supply voltage signal VDD is transferred to the input terminal of the compensation module through the turned-on first switch transistor, so as to supply the input voltage to the compensation module.

The above description is only taken as an example for explaining the particular configuration of the resetting module in the pixel compensation circuit. In a particular embodiment, the particular configuration of the resetting module is not limited to the configuration according to the embodiment of the present disclosure, and may be other configurations which are familiar for those skilled in the art and not limited.

Preferably, in the pixel compensation circuit according to an embodiment of the present disclosure, as shown in FIG. 2 and FIG. 3, the data writing module 12 particularly comprises a second switch transistor T2.

A gate of the second switch transistor T2 is the control terminal of the data writing module 12 and is connected to the second square wave signal G2. The first electrode of the second switch transistor T2 is the input terminal of the data writing module 12 and is connected to the data signal DATA. The second electrode of the second switch transistor T2 is the output terminal of the data writing module 12 and is connected to the control terminal of the compensation module 13.

Furthermore, as shown in FIG. 2, the second switch transistor T2 may be an N-type transistor. At this moment, when the second square wave signal G2 is at a high level, the second switch transistor T2 is in an on-state; and when the second square wave signal G2 is at a low level, the second switch transistor T2 is in an off-state. As shown in FIG. 3, the second switch transistor T2 may be a P-type transistor. At this moment, when the second square wave signal G2 is at a low level, the second switch transistor T2 is in an on-state; and when the second square wave signal G2 is at a high level, the second switch transistor T2 is in an off-state, which is not particularly limited.

In particular, in the pixel compensation circuit according to the embodiment of the present disclosure, when the second switch transistor T2 is in an on-state under control of the second square wave signal G2, the data signal DATA is transferred to the control terminal of the compensation module through the turned-on second switch transistor, so as to control the compensation module 13.

The above description is only taken as an example for explaining the particular configuration of the data writing module in the pixel compensation circuit. In a particular embodiment, the particular configuration of the data writing module is not limited to the configuration according to the embodiment of the present disclosure, and may be other configurations which are familiar for those skilled in the art and not limited.

Preferably, in the pixel compensation circuit according to an embodiment of the present disclosure, as shown in FIG. 2 and FIG. 3, the compensation module 13 particularly comprises a third switch transistor T3, a first capacitor C1 and a second capacitor C2.

A gate of the third switch transistor T3 is the control terminal of the compensation module 13 and is connected to the output terminal of the data driving module 12. The first electrode of the third switch transistor T3 is the input terminal of the compensation module 13 and is connected to the input terminal of the resetting module 11. The second electrode of the third switch transistor T3 is the output terminal of the compensation module 13 and is connected to an input terminal of the driving module 14.

A first electrode plate of the first capacitor C1 is connected to the control terminal of the third switch transistor T3, and a second electrode plate of the first capacitor C1 is connected to the second electrode of the third switch transistor T3.

The second capacitor C2 is connected between the first capacitor C1 and the ground.

Furthermore, as shown in FIG. 2, the third switch transistor T2 may be an N-type transistor. At this moment, when the output terminal of the data writing module outputs a high level, the third switch transistor T3 is in an on-state; and when the output terminal of the data writing module outputs a low level, the third switch transistor T3 is in an off-state. As shown in FIG. 3, the third switch transistor T3 may be a P-type transistor. At this moment, when the output terminal of the data writing module outputs a low level, the third switch transistor T3 is in an on-state; and when the output terminal of the data writing module outputs a high level, the third switch transistor T3 is in an off-state, which is not particularly limited.

In particular, in the pixel compensation circuit according to the embodiment of the present disclosure, when the fourth switch transistor T4 is turned on under control of the third square wave signal G3, the power supply voltage signal VDD is transferred to the output terminal of the driving module thought the turned-on third switch transistor T3 and the turned-on fourth switch transistor T4, so as to supply the power supply voltage signal to the light emitting device to drive the light emitting light to emit light.

The above description is only taken as an example for explaining the particular configuration of the driving module in the pixel compensation circuit. In a particular embodiment, the particular configuration of the driving module is not limited to the configuration according to the embodiment of the present disclosure, and may be other configurations which are familiar for those skilled in the art and not limited.

It should be noted that in the embodiments of the present disclosure as mentioned above, the first, second, third and fourth switch transistors may be thin film transistors (TFT) or Metal Oxide Semiconductor FET (MOSFET), which is not limited here. In a particular embodiment, the functions of the first and second electrodes of the transistors may be interchanged with each other according to the type of the transistor and the input signals, which is not distinguished herein.

In general, when the first, second, third and fourth switch transistors are P-type transistors, the first electrode is the source and the second electrode is the drain. When the first, second, third and fourth switch transistors are N-type transistors, the first electrode is the drain and the second electrode is the source.

Preferably, in the pixel compensation circuit according to an embodiment of the present disclosure, in order to simplify the process, the first, second, third and fourth switch transistors are all P-type transistors or N-type transistors, which is not limited herein.

More preferably, in the pixel compensation circuit according to an embodiment of the present disclosure, the first, second, third and fourth switch transistors may be all P-type transistors, which may simplify the process for manufacturing the pixel circuit.

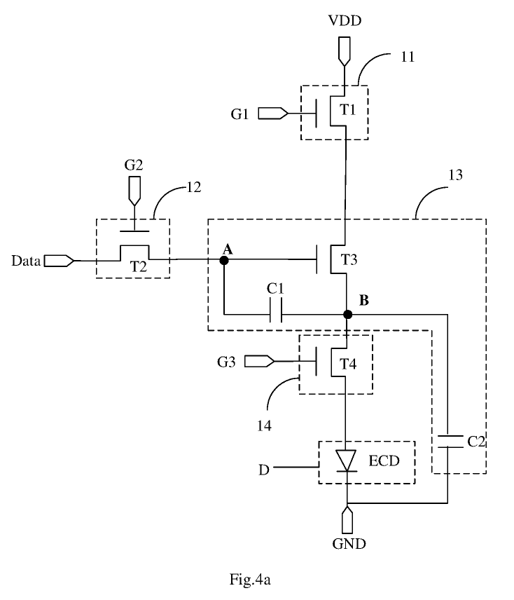

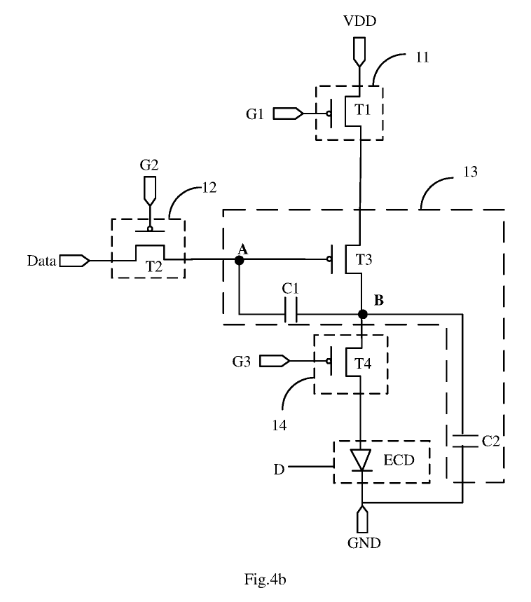

The pixel compensation circuits as shown in FIG. 4a and FIG. 4b are taken as an example to illustrate the operation process of the pixel compensation circuit according to the embodiment of the present disclosure. In order to facilitate illustration, the first terminal of the first capacitor C1 is designated as the first node A, and the second terminal of the first capacitor C1 is designated as the second Node B.

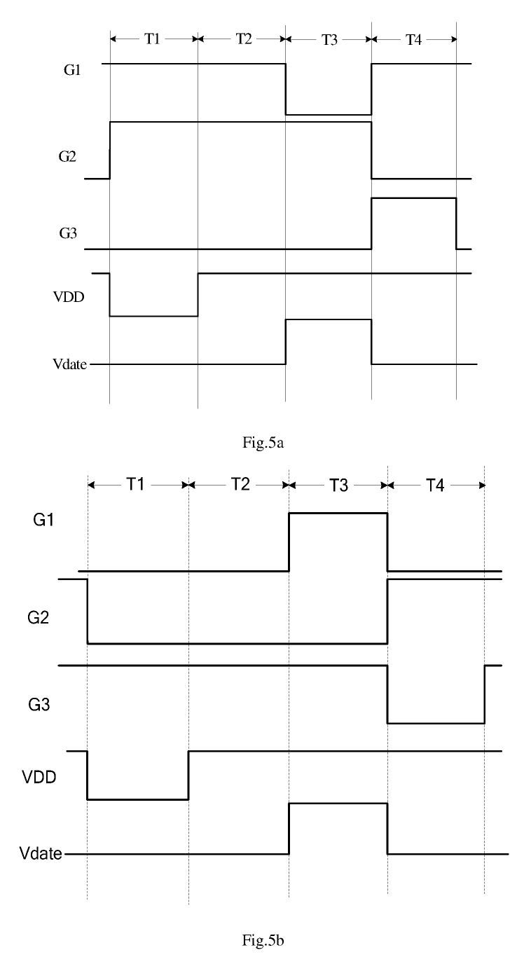

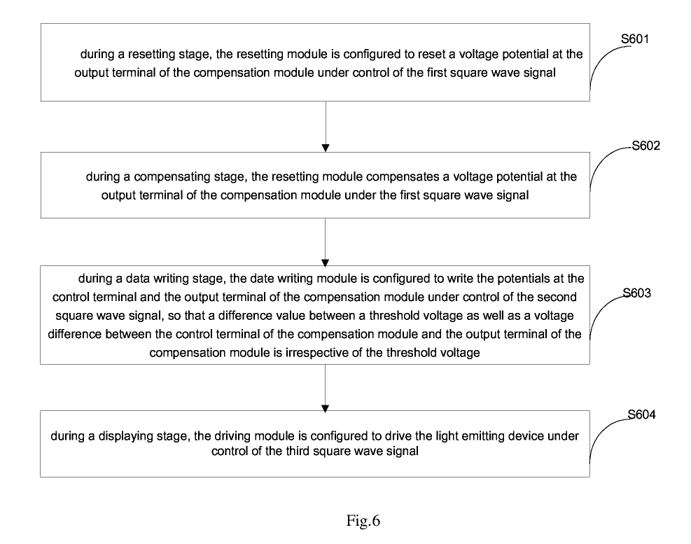

The operation process will be illustrated by taking the pixel compensation circuit as shown in FIG. 4a as an example. In the pixel compensation circuit shown in FIG. 4a, all of the switch transistors are all N-type transistors, each of which are turned on by a high level and are turned off by a low level. The corresponding time sequence chart is shown in FIG. 5a. In particular, the stages of T1, T2, T3 and T4 in the time sequence chart as shown in FIG. 5a are taken as an example for illustration in detail.

During the stage of T1, the first square wave signal G1 is at a high level, the second square wave signal G2 is at a high level, the third square wave signal G3 is at a low level, the power supply voltage signal VDD is at a low level and the data signal DATA=Vref, in which Vref>Vth.

The first switch transistor T1 and the second switch transistor T2 are in an on-state and the fourth switch transistor T4 is in an off-state, so the power supply voltage signal VDD is input to the input terminal of the third switch transistor T3 through the turned-on first switch transistor T1 and the data signal DATA is input to the first node A through the turned-on second switch transistor T2. The voltage of the first node A is Vref. Thus, the third switch transistor T3 is turned on, so that the power supply voltage signal VDD is input to the second node B through the turned-on first switch transistor T1 and the third switch transistor T3. The voltage of the second node B is reset to 0V.

During the stage of T2, the first square wave signal G1 is at a high level, the second square wave signal G2 is at a high level, the third square wave signal G3 is at a low level, the power supply voltage signal VDD is at a high level and the data signal DATA=Vref, in which Vref>Vth.

The first switch transistor T1 and the second switch transistor T2 are in an on-state and the fourth switch transistor T4 is in an off-state, so the power supply voltage signal VDD is input to the input terminal of the third switch transistor T3 through the turned-on first switch transistor T1 and the data signal DATA is input to the first node A through the turned-on second switch transistor T2. The voltage of the first node A is Vref. Thus, the third switch transistor T3 is turned on, so that the power supply voltage signal VDD is input to the second node B through the turned-on first switch transistor T1 and the third switch transistor T3. The voltage of the second node B is compensated to (Vref−Vth) V.

During the stage of T3, the first square wave signal G1 is at a low level, the second square wave signal G2 is at a high level, the third square wave signal G3 is at a low level, the power supply voltage signal VDD is at a high level and the data signal DATA is VD.

The first switch transistor T1 and the fourth switch transistor T4 are in an off-state and the second switch transistor T2 is in an on-state, so the data signal DATA is input to the first node A through the turned on second switch transistor T2; the voltage of the first node A UA=VD, so the third switch transistor T3 is turned on; the high level of the first node charges the second node B through the first capacitor C1 so that the potential of the second node B becomes UB=Vref−Vth+a(VD−Vref), in which a=C2/(C1+C2). Thus, the voltage difference between the first node A and the second node B is shown as UAB=UA−UB=(1−a)(VD−Vref)+Vth.

During the stage of T4, the first square wave signal G1 is at a high level, the second square wave signal G2 is at a low level, the third square wave signal G3 is at a high level, the power supply voltage signal VDD is at a high level and the data signal DATA=Vref.

The first switch transistor T1 and the fourth switch transistor T4 are in an on-state and the second switch transistor T2 is in an off-state. Since the first capacitor C1 has a function of storing electrical energy, the first capacitor C1 now functions as a power supply. Since the voltage difference between the first node A and the second node B is that UAB=UA−UB=(1−a)(VD−Vref)+Vth, it is apparent that the voltage difference between the first node A and the second node B is larger than the threshold voltage Vth and the third switch transistor T3 is turned on. The differential value between the threshold voltage Vth as well as the voltage difference between the first node A and the second node B is (1−a)(VD−Vref). It is apparent that the differential value between the threshold voltage Vth as well as the voltage difference between the first node A and the second node B is irrespective of the threshold voltage Vth. Consequently, when the third switch transistor T3 is turned on, (1−a)(VD−Vref) is always larger than 0 without considering the size of the threshold voltage Vth. Thus, the third switch transistor T3 is in an on-state, so that the high level of the power supply voltage signal VDD is input to the light emitting device D through the turned-on first switch transistor T1 and the third switch transistor T3 as well as the turned on fourth switch transistor T4.

To sum up, the voltage input to the light emitting device D is not affected by the threshold voltage Vth and is only related to the high level VD of the data signal DATA and the reference signal Vref. Thus, the present disclosure solves the issues of voltage caused by different threshold voltages for different switch devices which are due to manufacturing process and a long term of operations, thereby improving uneven displaying of the display panel and being capable of displaying frames with low grey scale by the display panel.

The operation process will be illustrated by taking the pixel compensation circuit as shown in FIG. 4b as an example. In the pixel compensation circuit shown in FIG. 4b, all of the switch transistors are all P-type transistors, each of which are turned on by a low level and are turned off by a high level. The corresponding time sequence chart is shown in FIG. 5b. In particular, the stages of T1, T2, T3 and T4 in the time sequence chart as shown in FIG. 5b are taken as an example for illustration in detail.

During the stage of T1, the first square wave signal G1 is at a low level, the second square wave signal G2 is at a low level, the third square wave signal G3 is at a high level, the power supply voltage signal VDD is at a low level and the data signal DATA=Vref, in which Vref>Vth.

The first switch transistor T1 and the second switch transistor T2 are in an on-state and the fourth switch transistor T4 is in an off-state, so the power supply voltage signal VDD is input to the input terminal of the third switch transistor T3 through the turned-on first switch transistor T1 and the data signal DATA is input to the first node A through the turned-on second switch transistor T2. The voltage of the first node A is Vref. Thus, the third switch transistor T3 is turned on, so that the power supply voltage signal VDD is input to the second node B through the turned-on first switch transistor T1 and the third switch transistor T3. The voltage of the second node B is reset to 0V.

During the stage of T2, the first square wave signal G1 is at a low level, the second square wave signal G2 is at a high level, the third square wave signal G3 is at a high level, the power supply voltage signal VDD is at a high level and the data signal DATA=Vref, in which Vref>Vth.

The first switch transistor T1 and the second switch transistor T2 are in an on-state and the fourth switch transistor T4 is in an off-state, so the power supply voltage signal VDD is input to the input terminal of the third switch transistor T3 through the turned-on first switch transistor T1 and the data signal DATA is input to the first node A through the turned-on second switch transistor T2. The voltage of the first node A is Vref. Thus, the third switch transistor T3 is turned on, so that the power supply voltage signal VDD is input to the second node B through the turned-on first switch transistor T1 and the third switch transistor T3. The voltage of the second node B is compensated to (Vref−Vth) V.

During the stage of T3, the first square wave signal G1 is at a high level, the second square wave signal G2 is at a low level, the third square wave signal G3 is at a high level, the power supply voltage signal VDD is at a high level and the data signal DATA is VD.

The first switch transistor T1 and the fourth switch transistor T4 are in an off-state and the second switch transistor T2 is in an on-state, so the data signal DATA is input to the first node A through the turned on second switch transistor T2; the voltage of the first node A UA=VD, so the third switch transistor T3 is turned on; the high level of the first node charges the second node B through the first capacitor C1 so that the potential of the second node B becomes UB=Vref−Vth+a(VD−Vref), in which a=C2/(C1+C2). Thus, the voltage difference between the first node A and the second node B is shown as UAB=UA−UB=(1−a)(VD−Vref)+Vth.

During the stage of T4, the first square wave signal G1 is at a low level, the second square wave signal G2 is at a high level, the third square wave signal G3 is at a low level, the power supply voltage signal VDD is at a high level and the data signal DATA=Vref.

The first switch transistor T1 and the fourth switch transistor T4 are in an on-state and the second switch transistor T2 is in an off-state. Since the first capacitor C1 has a function of storing electrical energy, the first capacitor C1 now functions as a power supply. Since the voltage difference between the first node A and the second node B is that UAB=UA−UB=(1−a)(VD−Vref)+Vth, it is apparent that the voltage difference between the first node A and the second node B is larger than the threshold voltage Vth and the third switch transistor T3 is turned on. The differential value between the threshold voltage Vth as well as the voltage difference between the first node A and the second node B is (1−a)(VD−Vref). It is apparent that the differential value between the threshold voltage Vth as well as the voltage difference between the first node A and the second node B is irrespective of the threshold voltage Vth. Consequently, when the third switch transistor T3 is turned on, (1−a)(VD−Vref) is always larger than 0 without considering the size of the threshold voltage Vth. Thus, the third switch transistor T3 is in an on-state, so that the high level of the power supply voltage signal VDD is input to the light emitting device D through the turned-on first switch transistor T1 and the third switch transistor T3 as well as the turned on fourth switch transistor T4.

To sum up, the voltage input to the light emitting device D is not affected by the threshold voltage Vth and is only related to the high level VD of the data signal DATA and the reference signal Vref. Thus, the present disclosure solves the issues of voltage caused by different threshold voltages for different switch devices which are due to manufacturing process and a long term of operations, thereby improving uneven displaying of the display panel and being capable of displaying frames with low grey scale by the display panel.

On the basis of the same inventive idea, the embodiment of the present disclosure further provides a display panel comprising any one of the pixel compensation circuits according to the embodiment of the present disclosure. Since the principle of the display panel for solving its technical issues is similar to that of the pixel compensation circuit, the embodiment of the pixel compensation circuit in the display panel may be referred to the embodiment of the pixel compensation circuit in the previous embodiment and is omitted for brevity.

On the basis of the same inventive idea, the embodiment of the present disclosure further provides a display device comprising the display panel according to the embodiment of the present disclosure. The display device may be display, mobile phone, television, notebook, all-in-one PC and so on. Other essential parts of the display device are appreciated for those skilled in the art so it is omitted for brevity.

On the basis of the same inventive idea, the embodiment of the present disclosure further provides a method for driving the pixel compensation circuit as mentioned above. As shown in FIG. 6, the method comprises the following steps.

S601, during a resetting stage, the resetting module is configured to reset a voltage potential at the output terminal of the compensation module under control of the first square wave signal;

S602, during a compensating stage, the resetting module compensates a voltage potential at the output terminal of the compensation module under the first square wave signal;

S603, during a data writing stage, the date writing module is configured to write the potentials at the control terminal and the output terminal of the compensation module under control of the second square wave signal, so that a difference value between a threshold voltage as well as a voltage difference between the control terminal of the compensation module and the output terminal of the compensation module is irrespective of the threshold voltage;

S604, during a displaying stage, the driving module is configured to drive the light emitting device under control of the third square wave signal.

The embodiment of the present disclosure provides a pixel compensation circuit and method for driving the same, a display panel and a display device which may solve the technical problem of instability of voltages caused by different threshold voltage Vth by cooperative operations of the respective modules of the pixel compensation circuit. When the light emitting device is controlled by the driving module to display, the difference value between a threshold voltage as well as a voltage difference between the control terminal of the compensation module and the output terminal of the compensation module is irrespective of the threshold voltage, so that the voltage supplied to the light emitting device will not be affected by the threshold voltage. Thus, the embodiment of the present disclosure provides a pixel compensation circuit to solve the technical problem of instability of voltages supplied to the light emitting device caused by different threshold voltage Vth, thereby improving uneven displaying of the display panel and being capable of displaying frames with low grey scale by the display panel.

Those skilled in the art may make any change and variant to the present disclosure without departing from the scope of the present invention. The present invention intends to cover all of the changes and modifications if those changes and modification falls in the scope of the claims and their equivalents.

1. A pixel compensation circuit, comprising a resetting module, a data writing module, a compensation module, a driving module and a light emitting device;
wherein a control terminal of the resetting module is connected to a first square wave signal, and an input terminal of the resetting module is connected to a power supply voltage signal; the resetting module is configured to supply the power supply voltage signal to the input terminal of the compensation module under control of the first square wave signal;
a control terminal of the data writing module is connected to a second square wave signal, and an input terminal of the data writing module is connected to a data signal; the data writing module is configured to supply a voltage signal of the data signal to the control terminal of the compensation module under control of the second square wave signal;
a control terminal of the compensation module is connected to an output terminal of the data writing module, and the input terminal of the compensation module is connected to an output terminal of the resetting module; the compensation module is configured to supply a voltage signal output by the output terminal of the resetting module to an input terminal of the driving module under control of a voltage signal output by the output terminal of the data writing module, and a difference value between a threshold voltage as well as a voltage difference between the control terminal of the compensation module and the output terminal of the compensation module is irrespective of the threshold voltage;
a control terminal of the driving module is connected to a third square wave signal, and the input terminal of the driving module is connected to the output terminal of the compensation module; the driving module is configured to drive the light emitting device under control of the third square wave signal.

2. The pixel compensation circuit according to claim 1, wherein the resetting module comprises a first switch transistor, wherein a gate of the first switch transistor is the control terminal of the resetting module, a first electrode of the first switch transistor is the input terminal of the resetting module, and a second electrode of the first switch transistor is the output terminal of the resetting module.

3. The pixel compensation circuit according to claim 1, wherein the data writing module comprises a second switch transistor, wherein a gate of the second switch transistor is the control terminal of the data writing module, a first electrode of the second switch transistor is the input terminal of the data writing module, and a second electrode of the second switch transistor is the output terminal of the data writing module.

4. The pixel compensation circuit according to claim 1, wherein the compensation module comprises a third switch transistor, a first capacitor and a second capacitor,
wherein a gate of the third switch transistor is the control terminal of the compensation module, a first electrode of the third switch transistor is the input terminal of the compensation module, and a second electrode of the third switch transistor is the output terminal of the compensation module;
a first electrode plate of the first capacitor is connected to the control terminal of the third switch transistor, and a second electrode plate of the first capacitor is connected to the second electrode of the third switch transistor; and
the second capacitor is connected between the first capacitor and ground.

5. The pixel compensation circuit according to claim 1, wherein the driving module comprises a fourth switch transistor,
wherein a gate of the fourth switch transistor is the control terminal of the driving module, a first electrode of the fourth switch transistor is the input terminal of the driving module, and a second electrode of the fourth switch transistor is the output terminal of the driving module.

6. The pixel compensation circuit according to claim 2, wherein the first switch transistor is a P-type transistor or N-type transistor.

7. The pixel compensation circuit according to claim 3, wherein the second switch transistor is a P-type transistor or N-type transistor.

8. The pixel compensation circuit according to claim 4, wherein the third switch transistor is a P-type transistor or N-type transistor.

9. The pixel compensation circuit according to claim 5, wherein the fourth switch transistor is a P-type transistor or N-type transistor.

10. A display panel comprising the pixel compensation circuit according to claim 1.

11. A display device comprising the display panel according to claim 10.

12. A method for driving a pixel compensation circuit comprising a resetting module, a data writing module, a compensation module, a driving module and a light emitting device, wherein a control terminal of the resetting module is connected to a first square wave signal, and an input terminal of the resetting module is connected to a power supply voltage signal; the resetting module is configured to supply the power supply voltage signal to the input terminal of the compensation module under control of the first square wave signal;
a control terminal of the data writing module is connected to a second square wave signal, and an input terminal of the data writing module is connected to a data signal; the data writing module is configured to supply a voltage signal of the data signal to the control terminal of the compensation module under control of the second square wave signal;
a control terminal of the compensation module is connected to an output terminal of the data writing module, and the input terminal of the compensation module is connected to an output terminal of the resetting module; the compensation module is configured to supply a voltage signal output by the output terminal of the resetting module to an input terminal of the driving module under control of a voltage signal output by the output terminal of the data writing module, and a difference value between a threshold voltage as well as a voltage difference between the control terminal of the compensation module and the output terminal of the compensation module is irrespective of the threshold voltage;
a control terminal of the driving module is connected to a third square wave signal, and the input terminal of the driving module is connected to the output terminal of the compensation module; the driving module is configured to drive the light emitting device under control of the third square wave signal,
the method comprising:
during a resetting stage, the resetting module is configured to reset a voltage potential at the output terminal of the compensation module under control of the first square wave signal;
during a compensating stage, the resetting module compensates a voltage potential at the output terminal of the compensation module under the first square wave signal;
during a data writing stage, the date writing module is configured to write the potentials at the control terminal and the output terminal of the compensation module under control of the second square wave signal, so that a difference value between a threshold voltage as well as a voltage difference between the control terminal of the compensation module and the output terminal of the compensation module is irrespective of the threshold voltage; and
during a displaying stage, the driving module is configured to drive the light emitting device under control of the third square wave signal.
